(19) United States
(12) Patent Application Publication
(10) Pub. No.: US 2021/0240183 A1
(43) Pub. Date: Aug. 5, 2021

(54) OUTPUT DEVICE, DRIVE DEVICE, MOBILE DEVICE, MOBILE BODY SYSTEM, OUTPUT METHOD, AND COMPUTER READABLE MEDIUM

(71) Applicant: NEC Corporation, Tokyo (JP)

(72) Inventor: Shinya YASUDA, Tokyo (JP)

(73) Assignee: NEC Corporation, Tokyo (JP)

(21) Appl. No.: 17/052,616

(22) PCT Filed: May 23, 2019
(86) PCT No.: PCT/JP2019/020451

§ 371 Date: Nov. 3, 2020

(30) Foreign Application Priority Data
May 31, 2018 (JP) 2018-104348

(51) Int. Cl. G05D 1/00; G05D 1/02

(52) U.S. Cl. CPC G05D 1/0088; G05D 2201/0216; G05D 1/0274; G05D 1/0022

(57) ABSTRACT

To make high precision movement possible when performing sending of positioning information to a mobile body via a wireless network, this output device comprises: a movement status derivation unit that derives a first status information which is information expressing the movement status of a mobile body, derived from status information expressing the execution status of an operation for a movement performed by each moveable part that executes the movement of the mobile body; a speed derivation unit that derives from the first status information a speed information that is information expressing the speed of the movement and the direction of the movement made possible by each of the moveable parts; and a speed correction unit that corrects the latest speed information from the relationship between error information expressing an error in the speed information and the speed information, and the latest speed information, and outputs the corrected speed information.

### TECHNICAL FIELD

The present invention relates to movement control of a mobile body.

### BACKGROUND ART

A movable device such as a robot or an unmanned conveyance vehicle for transporting a material and a load in a factory and a warehouse, and a control system thereof are being developed. The unmanned conveyance vehicle may be called an automated guided vehicle (AGV). A moving robot like the AGV may be called a movable robot.

The AGV is loaded with freight and moves along a predesignated path. The AGV then uses an encoder built in a drive unit such as a motor, and acquires an own position by reading the number of rotations of the motor or a wheel.

As the AGV, a vehicle is generally used that moves along a predesignated path by reading a magnetic marker embedded in a floor surface or a magnetic tape attached on a floor surface while moving. However, when such an AGV is used, it is necessary that a man-hour for reattaching a magnetic tape is necessary for every change of a line or layout in a factory.

In view of the above, an AGV that uses no magnetic tape, being a so-called trackless AGV, is more actively developed. For example, by equipping an AGV with a positioning sensor, real-time detecting a distance from a surrounding object, and associating the distance with a map, the trackless AGV moves along a designated movement path while spontaneously determining at which position on the map the own vehicle is located. NPL 1 discloses a fundamental principle of the trackless AGV.

Meanwhile, the trackless AGV has a disadvantage that a price has to be expensive because of necessity of a high-performance sensor. Thus, an aim of improving factory productivity by introducing a large number of trackless AGVs may not be cost-effective because of expensiveness of the price.

In order to solve the problem, PTL 1 discloses an AGV guidance system in which a sensor that occupies a large part of the price of the trackless AGV is provided externally. The AGV guidance system enables detection of absolute positions of a plurality of AGVs with a small number of sensors, by detecting positions of the AGVs with a shared external sensor. Thus, the AGV guidance system aims to reduce the price of the AGV.

In a method disclosed in PTL 1, an external positioning sensor sends positioning information relating to an AGV to the AGV by using a dedicated communication device. Thus, the method has a problem of inconvenience that a commercially available sensor device including a communication interface for a general-purpose wireless network and the like cannot be applied. In order to solve the problem, it is effective that the positioning information acquired by the external positioning sensor is sent to the AGV via a network such as a general-purpose wireless network.

PTL 2 discloses a conveyance device that corrects a position deviation being a difference between a position detection value and a position command value of a traveling truck by using a position correction value, and controls a traveling motor in such a way that the position deviation after correction approximates zero.

### CITATION LIST

### Patent Literature

[PTL 1] International Publication No. WO 2018/003814
[PTL 2] Japanese Unexamined Patent Application Publication No. 2016-188814

### Non Patent Literature

[NPL 1] Andrew J. Davison, “Real-Time Simultaneous Localisation and Mapping with a Single Camera,” Proceedings of the Ninth IEEE International Conference on Computer Vision—Volume 2, 2003, pages 1403 to 1410

### SUMMARY OF INVENTION

### Technical Problem

When positioning information is sent via a wireless network in the method disclosed in PTL 1, practically sufficient precision on movement control of an AGV may not be acquired for the following reason.

The reason is that, in the above-described method, communication delay due to the wireless network occurs, and thus, it is possible to acquire only past information sent earlier by the communication delay. In the above-described method, order of the positioning information arriving at the AGV is reversed because of possibility that the communication delay may vary, and, normally, frequency of acquiring the positioning information has to be lowered in comparison with a case where the AGV includes a positioning sensor internally. In other words, in the above-described method, the above-described information with the communication delay can only be acquired with low frequency.

In general, during a period from when one piece of the above-described information is acquired to when a next piece of the above-described information is acquired, a position of the AGV is estimated by using information from an encoder placed on a wheel or the like. However, an error in position estimation using encoder information increases with a lapse of time. Thus, when the above-described information with the communication delay can only be acquired with low frequency as described above, an error in position estimation of the AGV enlarges.

PTL 1 also discloses a method in which, in addition to the sensor provided outside the AGV, each AGV is also equipped with a positioning sensor for deriving a position of the AGV. However, the method involves an increase in cost, because positioning sensors as many as the number of the AGVs are necessary.

An object of the present invention is to provide an output device and the like that can output information for enabling high-precision movement when positioning information acquired by a positioning sensor provided outside a mobile body is sent to the mobile body via a wireless network.

### Solution to Problem

An output device according to the present invention includes: a movement status derivation unit deriving first status information that is information representing a movement status of a mobile body and is derived from status information representing an execution status of an operation for movement of the mobile body being performed by each of movement enabling units executing the movement; a speed derivation unit deriving, from the first status information, speed information that is information representing a speed of the movement and a direction of the movement being enabled by each of the movement enabling units; and a speed correction unit correcting the latest speed information from the latest speed information and a relationship between the speed information and error information representing an error in the speed information, and outputting corrected speed information that is the speed information after correction.

### Advantageous Effects of Invention

An output device and the like according to the present invention is able to output information that can enable high-precision movement when positioning information acquired by a positioning sensor provided outside a mobile body is sent to the mobile body via a wireless network.

### BRIEF DESCRIPTION OF DRAWINGS

FIG. 1 is a conceptual diagram illustrating a configuration example of a mobile body system according to a first example embodiment.

FIG. 2 is a conceptual diagram illustrating an example of a method of deriving speed correction information from combination information.

FIG. 3 is a conceptual diagram illustrating a processing flow example of processing performed by a position estimation unit.

FIG. 4 is a conceptual diagram illustrating a processing flow example of processing performed by a speed derivation unit.

FIG. 5 is a conceptual diagram illustrating a processing flow example of processing performed by a position difference derivation unit.

FIG. 6 is a conceptual diagram illustrating a processing flow example of processing performed by a position correction unit.

FIG. 7 is a conceptual diagram illustrating a processing flow example of processing performed by a speed error derivation unit.

FIG. 8 is a conceptual diagram illustrating a processing flow example of processing performed by a speed correction derivation unit.

FIG. 9 is a conceptual diagram illustrating a processing flow example of processing performed by a speed correction unit.

FIG. 10 is a conceptual diagram illustrating a processing flow example of processing performed by a drive unit.

FIG. 11 is a conceptual diagram illustrating an example of a method of deriving speed correction information from combination information according to a second example embodiment.

FIG. 12 is a conceptual diagram illustrating a first configuration example of a mobile body system according to a third example embodiment.

FIG. 13 is a conceptual diagram illustrating a second configuration example of the mobile body system according to the third example embodiment.

FIG. 14 is a conceptual diagram illustrating a first configuration example of a mobile body system according to a fourth example embodiment.

FIG. 15 is a conceptual diagram illustrating a second configuration example of the mobile body system according to the fourth example embodiment.

FIG. 16 is a conceptual diagram illustrating a hardware configuration example of an information processing device that can achieve a part for performing information processing and communication in a positioning device and a mobile body according to each of the example embodiments.

FIG. 17 is a block diagram illustrating a minimum configuration of an output device according to the example embodiment.

### EXAMPLE EMBODIMENT

### First Example Embodiment

A first example embodiment is an example embodiment relating to a mobile body system, regarding a case where an error model holds in which an error in information representing a magnitude and a direction of a speed of a mobile body takes a linear value relative to the information.

A mobile body according to the first example embodiment corrects, by using speed correction information, information representing a magnitude and a direction of a speed of the mobile body, such as a circumferential speed of each drive wheel or the like estimated as necessary for the mobile body to advance along a predetermined path. The speed correction information is derived by the mobile body, from an error in a magnitude and a direction of a speed of the mobile body derived from a position of the mobile body acquired by an external positioning device, and from information representing a magnitude and a direction of a speed of the mobile body associated with the error. With the above-described operation, the circumferential speed or the like of each drive wheel or the like is corrected into a value closer to a value actually necessary for advancing along the path, in comparison with a case where correction using the speed correction information is not performed. Thus, the mobile body enables higher-precision movement control, in comparison with a case where positioning information acquired by an external positioning sensor is sent to a mobile body via a wireless network in the method disclosed in PTL 1.

### Configuration and Operation

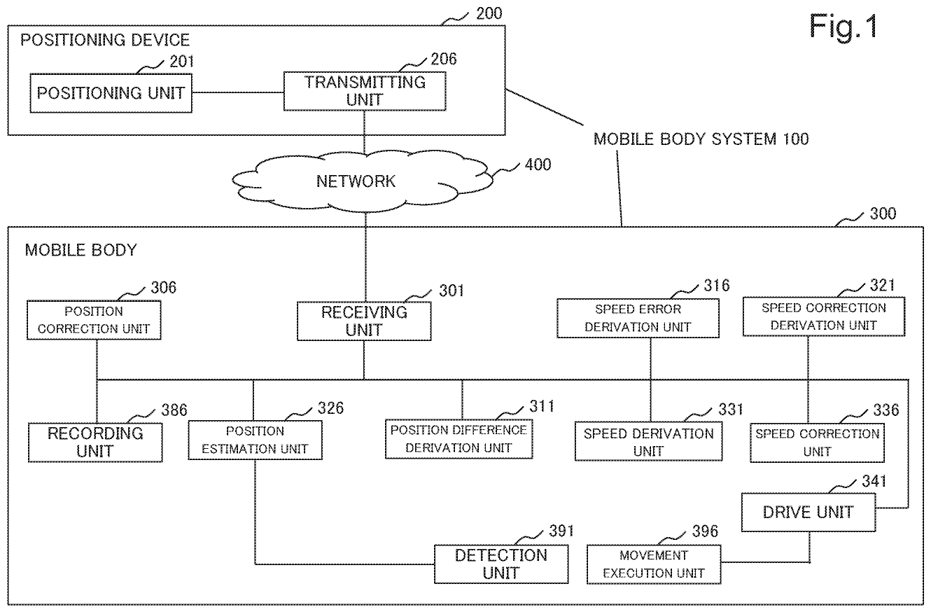

FIG. 1 is a conceptual diagram illustrating a configuration of a mobile body system 100 being an example of the mobile body system according to the first example embodiment.

The mobile body system 100 includes a positioning device 200 and a mobile body 300.

The positioning device 200 includes a positioning unit 201 and a transmitting unit 206.

Hereinafter, a detail of an operation performed by each configuration of the mobile body system 100 illustrated in FIG. 1 will be described.

The positioning unit 201 specifies a position of the mobile body 300 externally of the mobile body 300.

The positioning unit 201 specifies the mobile body 300, for example, by means of image recognition using image information photographed by a camera installed around a location where the mobile body 300 is operating. An installation location for the installation is, for example, a ceiling within a building where the mobile body 300 is operating.

The camera is, for example, a twin-lens camera. In that case, the positioning unit 201 can specify a distance to the mobile body 300 and a direction of the mobile body 300 from a parallax of a twin-lens camera image. As the above-described twin-lens camera, for example, the ZED (registered trademark) camera manufactured by Stereolabs may be used. Then, the positioning unit 201 derives a position of the mobile body 300 by using a position of the camera, a distance from the camera to the mobile body 300, and a direction of an object.

The transmitting unit 206 transmits position information representing the position of the mobile body 300 derived by the positioning unit 201, to the mobile body 300 via a network 400.

The network 400 is, for example, a network for wireless internet protocol (IP) communication such as Wi-Fi (registered trademark).

The mobile body 300 is, for example, the AGV or the movable robot described in paragraphs of Background Art.

The mobile body 300 includes a receiving unit 301, a position correction unit 306, a position difference derivation unit 311, a speed error derivation unit 316, a speed correction derivation unit 321, and a position estimation unit 326. The mobile body 300 further includes a speed derivation unit 331, a speed correction unit 336, a drive unit 341, a detection unit 391, a movement execution unit 396, and a recording unit 386.

The movement execution unit 396 executes movement of the mobile body 300 by being driven by the drive unit 341.

The movement execution unit 396 includes, for example, unillustrated movement enabling units that enable movement of the mobile body 300. The movement enabling units are, for example, drive wheels. The drive wheels are, for example, drive wheels of a two-wheeled shaft. In that case, left and right drive wheels can be rotary driven individually by the drive unit 341 at different circumferential speeds. Herein, the circumferential speed is a speed at which the circumference of the drive wheel rotary moves. When there is no sliding against an installation surface of the drive wheel, the circumferential speed is equal to a speed at which the center of the drive wheel moves. With the above-described operation, the movement execution unit 396 enables movement and turning of the mobile body 300 by making use of a difference in speeds of the left and right drive wheels. The circumferential speeds of the drive wheels are information representing a magnitude and a direction of a movement speed of the mobile body 300.

In the following description about the first example embodiment, the movement execution unit 396 includes the above-described drive wheels of the two-wheeled shaft, insofar as there is no particular remark otherwise stated.

The detection unit 391 acquires status information representing an execution status of the movement performed by the movement execution unit 396. The detection unit 391 successively sends the acquired status information to the position estimation unit 326.

When the movement execution unit 396 includes the above-described drive wheels, the detection unit 391 is, for example, an encoder that detects a rotation of each of the left and right drive wheels. In this case, information representing a set of rotation amounts of the left and right drive wheels is the above-described status information representing the execution status of the movement.

In the following description about the first example embodiment, it is assumed that the detection unit 391 successively sends, to the position estimation unit 326, the status information representing rotations of the left and right drive wheels included in the movement execution unit 396.

The receiving unit 301 causes the recording unit 386 to hold information sent from the positioning device 200 via the network 400.

Among the above-described configurations included in the mobile body 300, units other than the receiving unit 301, the detection unit 391, and the movement execution unit 396 perform first processing and second processing. The first processing is processing of deriving a combination group consisting of combinations of a speed error of the mobile body 300 derived from the position of the mobile body 300 acquired by the positioning device 200 and a speed of the mobile body associated with the error. The combinations are derived at different times. The speed of the mobile body 300 varies depending on time. Accordingly, the combination group includes the combinations associated with a plurality of speeds. Meanwhile, the second processing is processing of deriving speed correction information for correcting the latest speed of the mobile body 300, from the combination group, the latest speed of the mobile body 300, and the combination group. A second frequency with which the mobile body 300 performs the second processing is higher than a first frequency with which the mobile body 300 performs the first processing.

First, the second processing will be described.

The second processing is processing performed by the position estimation unit 326, the speed derivation unit 331, the speed correction derivation unit 321, the speed correction unit 336, and the drive unit 341, based on the above-described status information sent by the detection unit 391 to the position estimation unit 326.

As the second processing, the position estimation unit 326 derives estimated position information representing an estimated position of the mobile body 300, by using the status information at a second timing associated with the second frequency. At that time, the position estimation unit 326 derives estimated position information that is information representing an estimated value of a position of the mobile body 300 as a relative displacement from a reference point (for example, a point from which the mobile body 300 starts to move). The estimated position represented by the estimated position information includes an error, as described in paragraphs of Technical Problem. The position estimation unit 326 causes the recording unit 386 to hold the estimated position information.

When the new estimated position information is stored in the recording unit 386 by the position estimation unit 326, the speed derivation unit 331 derives, from the estimated position information, circumferential speeds of the drive wheels for moving along a target path. Since the estimated position information includes an error as described above, the circumferential speed derived from the estimated position information includes an error. The speed derivation unit 331 causes the recording unit 386 to hold speed information representing a set of the derived circumferential speeds of the drive wheels. The set of the circumferential speeds represents a magnitude and a direction of a speed at which the mobile body 300 moves. Accordingly, the speed information is information representing a magnitude and a direction of a speed at which the mobile body 300 moves.

When the new speed information is stored in the recording unit 386, the speed correction derivation unit 321 reads the latest speed information from the recording unit 386. Then, the speed correction derivation unit 321 derives speed correction information associated with the read speed information, from the read speed information and a combination group to be described later and being held in the recording unit 386 at the point of time. Herein, the speed correction information is information for correcting the speed information by the speed correction unit 336. When the speed information represents the circumferential speeds of the drive wheels, the speed correction information is information for correcting each of the circumferential speeds. A combination constituting the combination group is derived through the first processing. A method of deriving the speed correction information by using the combination group and the latest speed information will be described later.

The speed correction derivation unit 321 causes the recording unit 386 to hold the derived speed correction information. At that time, the speed correction derivation unit 321 may cause the recording unit 386 to discard the past speed correction information held in the recording unit 386.

When the new speed correction information is stored in the recording unit 386 by the speed error derivation unit 316, the speed correction unit 336 generates the speed information after correction (corrected speed information) that is acquired by correcting the latest speed information held in the recording unit 386 by using the speed correction information. When the speed information is the set of the circumferential speeds, the corrected speed information is the set of the circumferential speeds after correction. Then, the speed correction unit 336 causes the recording unit 386 to hold the generated corrected speed information.

The drive unit 341 drives the drive wheels included in the movement execution unit 396, according to the latest corrected speed information stored in the recording unit 386.

Next, the above-described first processing will be described.

The first processing is processing of deriving the speed correction information for correcting the speed information by the speed correction unit 336, by using the above-described position information received by the mobile body 300 from the positioning device 200. The first processing is performed by the position correction unit 306, the position difference derivation unit 311, and the speed error derivation unit 316.

As the first processing, the position difference derivation unit 311 derives difference information representing a difference between the latest position information stored in the recording unit 386 and the latest estimated position information stored in the recording unit 386, at a first timing associated with the first frequency. Herein, the position information is received by the receiving unit 301 from the positioning device 200 via the network 400, and is stored in the recording unit 386 by the receiving unit 301. The estimated position information is derived by the position estimation unit 326, and is stored in the recording unit 386.

The position difference derivation unit 311 causes the recording unit 386 to store the derived difference position information. At that time, the position difference derivation unit 311 may cause the recording unit 386 to discard the difference position information previously held in the recording unit 386.

When the new difference information is stored in the recording unit 386 by the position difference derivation unit 311, the position correction unit 306 corrects the latest estimated position information that is derived by the position estimation unit 326 and is held in the recording unit 386. The position correction unit 306 performs the correction in such a way that the difference represented by the difference information derived by the position difference derivation unit 311 becomes zero. Instead of the correction, the position correction unit 306 may replace an estimated position of the estimated position information held in the recording unit 386 with a position represented by the position information held in the recording unit 386.

When the new difference information is stored in the recording unit by the position difference derivation unit 311, the speed error derivation unit 316 derives errors in the circumferential speeds of the drive wheels. The speed error derivation unit 316 causes the recording unit 386 to hold speed error information representing a set of the derived errors in the circumferential speeds of the drive wheels. At that time, the speed error derivation unit 316 causes the recording unit 386 to hold a combination of the derived speed error information and the latest speed information held in the recording unit 386. Even when the speed error derivation unit 316 causes the recording unit 386 to newly hold the combination held in the recording unit 386, the speed error derivation unit 316 does not cause the recording unit 386 to discard the combination held in the recording unit 386 in the past. Consequently, the recording unit 386 holds a combination group consisting of the combinations newly held at different timings.

The recording unit 386 holds sent information, according to an instruction from the configurations. When storing information, the recording unit 386 holds a time relating to the storage, in combination with the information to be stored. The recording unit 386 discards held information instructed from the configurations. The recording unit 386 sends instructed information, according to an instruction from the configurations.

Next, a detail of the first processing will be described.

First, an error model relating to an error in a speed and applied according to the example embodiment will be described. As described above, the circumferential speed of each drive wheel represented by the speed information derived by the speed derivation unit 331 does not always match the circumferential speed necessary for each drive wheel to actually move the mobile body 300. Further, the error is considered as dependent on at least the circumferential speed. In view of this, the actual circumferential speed of the drive wheel when a circumferential speed v is an instructed value is defined as below.

v+α(v) Expression 1

Herein, α is a circumferential speed error. Assuming that the movement execution unit 396 includes the drive wheels of the two-wheeled shaft as described above, the circumferential speeds of the left and right drive wheels are defined as vₗ and vᵣ, respectively. In that case, the actual circumferential speeds of the left and right drive wheels are expressed as below.

vₗ+αₗ(vₗ)

and

vᵣ+αᵣ(vᵣ)

Next, a method of calculating the circumferential speed error α by using the position information sent from the positioning device 200 will be described.

It is assumed that a timing interval relating to the first timing is a time τ. At this time, the position estimation unit 326 derives, by using the status information sent from the detection unit 391, an estimated moving distance rₖ and an estimated turning angle θₖ of the mobile body 300 for the time τ as below.

$$\{ \begin{matrix}{r}_{k} = \frac{v + {v}_{1}}{2} τ \\ {θ}_{k} = \frac{{v}_{r} - {v}_{1}}{d} τ\end{matrix} \qquad Expression 2$$

Herein, a distance d is a distance between the left and right drive wheels.

Meanwhile, the position information sent from the positioning device 200 is considered as including influence of the circumferential speed error α that cannot be acquired from the status information. Thus, when the above-described error model represented by Expression 1 is used for a moving distance and a turning angle of the mobile body 300 for the time τ according to the position information, an actual moving distance r_{c} and an actual turning angle θ_{c} for the time τ sent from the positioning device 200 are expressed as below.

$$\{ \begin{matrix}{r}_{c} = \frac{{v}_{r} + {α}_{r} + {v}_{1} + {α}_{1}}{2} τ \\ {θ}_{c} = \frac{{v}_{r} + {α}_{r} - {v}_{1} - {α}_{1}}{d} τ\end{matrix} \qquad Expression 3$$

From Expression 3, circumferential speed errors αᵣ and αₗ of the left and right drive wheels are derived as below.

$$\{ \begin{matrix}{α}_{r} = \frac{1}{2 τ} [ 2 ( {r}_{c} - {r}_{k} ) + d ( {θ}_{c} - {θ}_{k} ) ] \\ {α}_{1} = \frac{1}{2 τ} [ 2 ( {r}_{c} - {r}_{k} ) - d ( {θ}_{c} - {θ}_{k} ) ]\end{matrix} \qquad Expression 4$$

Accordingly, by using the estimated moving distance rₖ and the estimated turning angle θₖ, the actual moving distance r_{c} and the actual turning angle θ_{c} for the time τ sent from the positioning device 200, and Expression 4, the circumferential speed errors αᵣ and αₗ of the left and right drive wheels can be derived. Herein, the estimated moving distance rₖ and the estimated turning angle θₖ are the estimated moving distance and the estimated turning angle of the mobile body 300 for the time τ derived by using Expression 2.

The position difference derivation unit 311 illustrated in FIG. 1 derives a moving distance difference r_{c}−rₖ and a turning angle difference θ_{c}−θₖ in Expression 4.

The speed error derivation unit 316 derives, from the moving distance difference r_{c}-rₖ and the turning angle difference θ_{c}-θₖ sent from the position difference derivation unit 311, the time τ, and Expression 4, the circumferential speed errors αᵣ and αₗ being the circumferential speed errors of the left and right drive wheels. It is assumed that the time τ is stored in, for example, an unillustrated predetermined recording unit, and that the speed error derivation unit 316 is able to read the time τ from the recording unit as needed.

Even in a case where the drive wheels included in the movement execution unit 396 are not of a two-wheeled shaft, the speed error derivation unit 316 is able to estimate an error in an operation performed by the movement execution unit 396 in the following case, by simultaneously satisfying the expressions in a similar way as described above. The case is a case where the status information representing the execution status of movement performed by the movement execution unit 396 represents a position of the mobile body 300 and a direction of movement.

For example, when the movement execution unit 396 is constituted of a steering and a drive wheel like a motorcycle or an automobile, the error in the operation is an error relating to a steering angle of the steering and a circumferential speed of the drive wheel. When the mobile body 300 is something like a motorcycle or an automobile, the speed error derivation unit 316 is able to estimate the error in the operation performed by the movement execution unit 396, by simultaneously satisfying the error relating to the steering angle and the error relating to the circumferential speed of the drive wheel.

Next, a speed correction operation performed by the speed correction derivation unit 321 will be described.

The speed correction derivation unit 321 corrects the circumferential speeds of the drive wheels represented by the speed information derived by the speed derivation unit 331, by using the speed correction information associated with the circumferential speeds.

The speed error derivation unit 316 derives the speed error information at the first timing, and causes the recording unit 386 to hold a combination of the speed error information and the speed information derived by the speed derivation unit 331 at the latest second timing, as described above. Thus, the recording unit 386 holds a combination group consisting of the combinations at the first timing, as described above.

Meanwhile, for correcting the speed information, the speed correction unit 336 needs the speed correction information associated with the speed information derived by the speed derivation unit 331 at the second timing.

Since the second timing is more frequent than the first timing as described above, the recording unit 386 often does not hold the speed correction information for correcting the above-described speed information at the second timing.

In view of the above, the speed correction derivation unit 321 derives the speed correction information to be sent to the speed correction unit 336, by using, for example, a method described below.

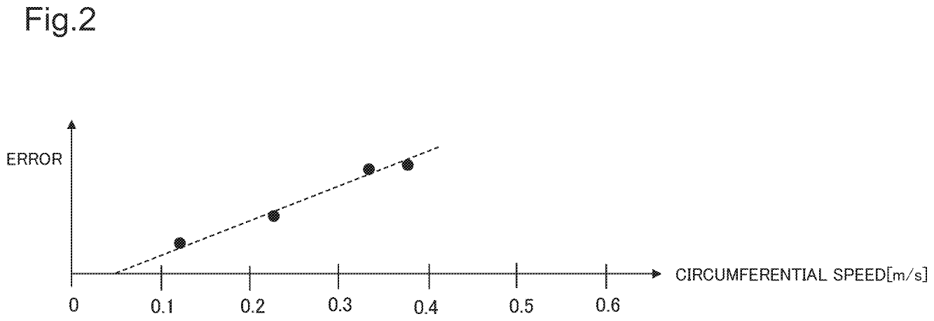

FIG. 2 is a conceptual diagram illustrating an example of a method of deriving the speed correction information from the above-described combination information group.

Each dot illustrated in FIG. 2 represents the above-described combination derived by the speed error derivation unit 316. The speed correction derivation unit 321 calculates a straight line approximating the combination, by using linear approximation. It is assumed that, as a result of the linear approximation, the circumferential speed error α is represented as below.

α=β×v+γ

In that case, a relationship between the circumferential speed error α and the circumferential speed v using coefficients β and γ can be derived.

Next, correction of the speed information performed by the speed correction unit 336 by using the speed correction information will be described.

A case is assumed in which a certain drive wheel of the mobile body 300 is desired to be operated at a circumferential speed v1. In that case, the speed derivation unit 331 outputs the circumferential speed v1. Due to influence of the circumferential speed error, it is assumed that, when the drive unit 341 drives the drive wheel by using the speed information representing the circumferential speed v1, the circumferential speed of the drive wheel is actually expressed as below.

β×v1+γ

In that case, in order to rotate the drive wheel at the circumferential speed v1, the speed correction unit 336 needs to correct the circumferential speed v1 in such a way that the corrected speed information representing the corrected circumferential speed can be used by the drive unit 341. The circumferential speed after correction in that case is defined as a circumferential speed v2. In that case, the circumferential speed v2 can be calculated as a solution of below.

v1=v2+α(v2)

In the case of the above-described operation example of the speed correction derivation unit 321, solving the above expression gives below.

$$v 2 = \frac{v 1 - γ}{β + 1}$$

As described above, the mobile body system 100 corrects the circumferential speeds for driving the drive wheels, by using the speed correction information derived from the combination group and the circumferential speeds therein. Thus, the mobile body system 100 enables higher-precision movement control of a mobile body, in comparison with a case where positioning information is sent from an external positioning device to a mobile body via a wireless network in the method represented in PTL 1. The reason is that the method represented in PTL 1 only performs correction of a position by using the positioning information from the external positioning sensor.

The method disclosed in PTL 2 is supposed to achieve high-precision movement by performing correction of a position of a mobile body. However, the mobile body system 100 further performs, when performing correction of a position, correction of a speed using the error model. Thus, the mobile body system according to the present example embodiment can perform higher-precision movement control of a mobile body, in comparison with a case where positioning information is sent from an external positioning device to a mobile body via a wireless network in the method disclosed in PTL 1. The reason is that the method disclosed in PTL 1 performs correction of a position but does not perform correction of a speed.

### [Processing Flow Example]

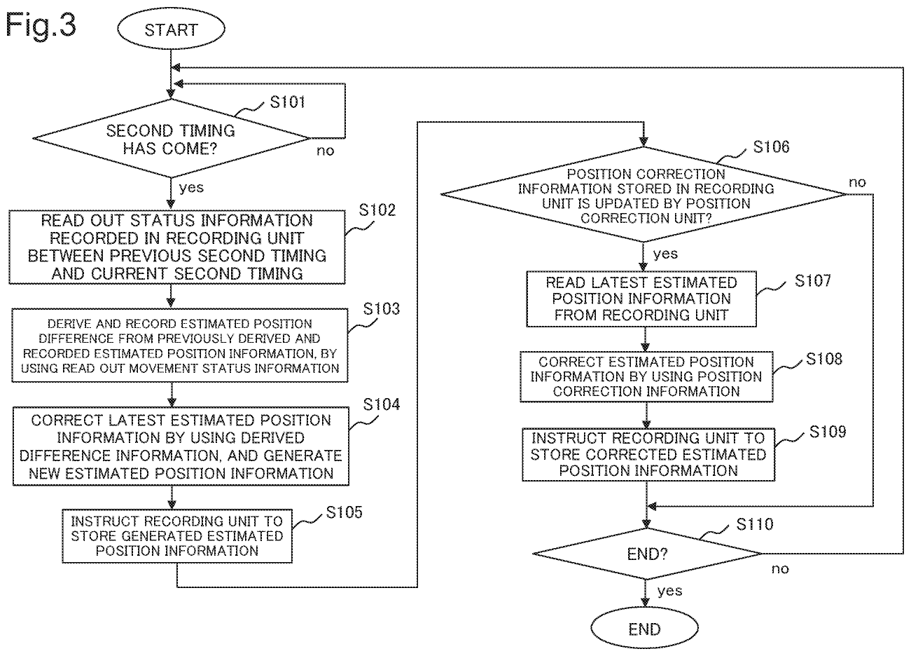

FIG. 3 is a conceptual diagram illustrating a processing flow example of processing performed by the position estimation unit 326 illustrated in FIG. 1.

As a premise of the processing illustrated in FIG. 3, it is assumed that the position estimation unit 326 causes the recording unit 386 to successively store the status information sent from the detection unit 391. The recording unit 386 holds the status information at a storage position for storing the status information, in association with a time of storing the status information.

The position estimation unit 326 starts the processing illustrated in FIG. 3, for example, upon input of start information from outside.

Then, as processing of S101, the position estimation unit 326 performs determination as to whether the above-described second timing has come. The position estimation unit 326 performs the determination, for example, by referring to a clock time. Herein, it is premised that the position estimation unit 326 can use an unillustrated clock.

When a determination result in the processing of S101 is yes, the position estimation unit 326 performs processing of S102.

Meanwhile, when a determination result in the processing of S101 is no, the position estimation unit 326 performs the processing of S101 again.

When performing the processing of S102, as the processing, the position estimation unit 326 reads out the status information that is relevant to a period from a time of the previous second timing to a time of the current second timing and is stored in the recording unit 386 illustrated in FIG. 1. When the detection unit 391 is an encoder, the status information is, for example, a count value of the encoder.

Then, as processing of S103, the position estimation unit 326 derives, by using the status information read out in the processing of S102, an estimated position difference that is a difference from the estimated position information stored in the recording unit 386 at the previous second timing. The position estimation unit 326 derives the estimated position difference, for example, by multiplying a count integrated value of the encoder for the drive wheels by a length of an outer diameter of a target drive wheel. The position estimation unit 326 causes the recording unit 386 to store the derived estimated position difference at a storage position in the recording unit 386 for storing the estimated position difference.

Then, as processing of S104, the position estimation unit 326 corrects, by using the estimated position difference derived in the processing of S103, the latest estimated position information held in the recording unit 386, and generates the new estimated position information.

Then, as processing of S105, the position estimation unit 326 causes the recording unit 386 to store the new estimated position information generated in the processing of S104.

Then, as processing of S106, the position estimation unit 326 performs determination as to whether position correction information stored in the recording unit 386 is updated by the position correction unit 306. It is assumed that the position correction unit 306 causes the recording unit 386 to update the position correction information stored at the storage position in the recording unit 386 for storing the position correction information, through processing to be described later.

When a determination result in the processing of S106 is yes, the position estimation unit 326 performs processing of S107.

Meanwhile, when a determination result in the processing of S106 is no, the position estimation unit 326 performs processing of S110.

When performing the processing of S107, as the processing, the position estimation unit 326 reads the latest estimated position information from the recording unit 386.

Then, as processing of S108, the position estimation unit 326 corrects the estimated position information read in the processing of S107, by using the latest position correction information held in the recording unit 386.

Then, as processing of S109, the position estimation unit 326 causes the recording unit 386 to store the estimated position information corrected in the processing of S108. Then, the position estimation unit 326 performs the processing of S110.

When performing the processing of S110, as the processing, the position estimation unit 326 performs determination as to whether to end the processing illustrated in FIG. 3. The position estimation unit 326 performs the determination by determining presence and absence of input of end information from outside.

When a determination result in the processing of S110 is yes, the position estimation unit 326 ends the processing illustrated in FIG. 3.

Meanwhile, when a determination result in the processing of S110 is no, the position estimation unit 326 performs the processing of S101 again.

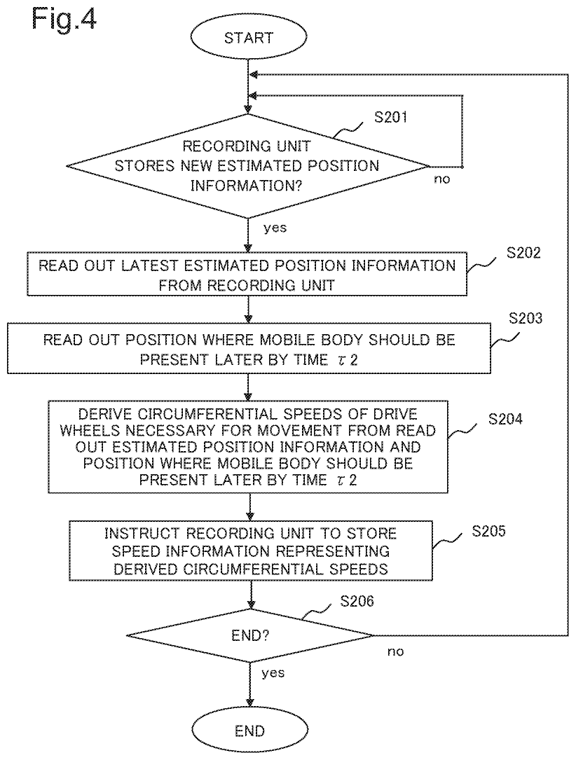

FIG. 4 is a conceptual diagram illustrating a processing flow example of processing performed by the speed derivation unit 331 illustrated in FIG. 1.

The speed derivation unit 331 starts the processing illustrated in FIG. 4, for example, upon input of start information from outside.

Then, as processing of S201, the speed derivation unit 331 performs determination as to whether the new estimated position information is stored at a predetermined storage position in the recording unit 386. The new estimated position information is stored in the recording unit 386 by the position estimation unit 326 through the processing illustrated in FIG. 3.

When a determination result in the processing of S201 is yes, the speed derivation unit 331 performs processing of S202.

When a determination result in the processing of S201 is no, the speed derivation unit 331 performs the processing of S201 again.

When performing the processing of S202, as the processing, the speed derivation unit 331 reads, from the recording unit 386, the latest estimated position information held in the recording unit 386.

Then, as processing of S203, the speed derivation unit 331 reads out, from the recording unit 386, expected position information that is information representing a position where the mobile body 300 should be present later by the time τ2. It is assumed that the expected position information is held in the recording unit 386 in advance.

Then, as processing of S204, the speed derivation unit 331 derives the circumferential speeds of the drive wheels, from the latest estimated position information read from the recording unit 386 in the processing of S202 and the expected position information read from the recording unit 386 in the processing of S203. The circumferential speed is a circumferential speed expected for enabling movement in a period of the time T2 from a position represented by the estimated position information to a position represented by the expected position information.

Then, as processing of S205, the speed derivation unit 331 causes the recording unit 386 to store the speed information representing the circumferential speeds derived in the processing of S204.

Then, as processing of S206, the speed derivation unit 331 performs determination as to whether to end the processing illustrated in FIG. 4.

When a determination result in the processing of S206 is yes, the speed derivation unit 331 ends the processing illustrated in FIG. 4.

Meanwhile, when a determination result in the processing of S206 is no, the speed derivation unit 331 performs the processing of S201 again.

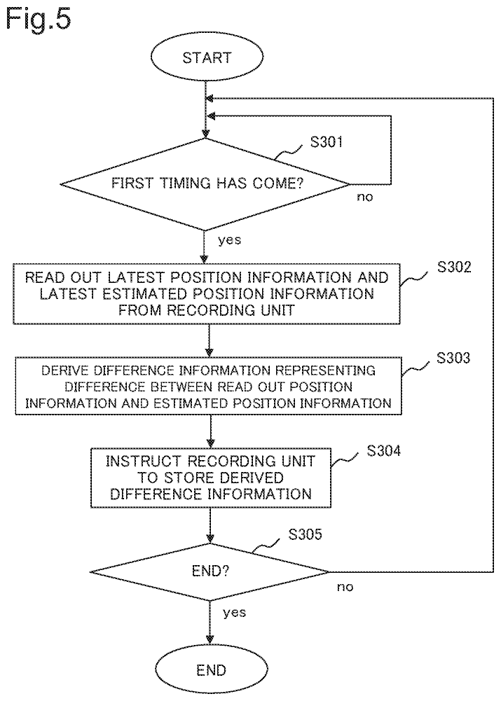

FIG. 5 is a conceptual diagram illustrating a processing flow example of processing performed by the position difference derivation unit 311 illustrated in FIG. 1.

The position difference derivation unit 311 starts the processing illustrated in FIG. 5, for example, upon input of start information from outside.

Then, as processing of S301, the position difference derivation unit 311 performs determination as to whether the above-described first timing has come. The position difference derivation unit 311 performs the determination, for example, by determining whether a clock time is a time representing the first timing. It is premised that the position difference derivation unit 311 can use a clock.

When a determination result in the processing of S301 is yes, the position difference derivation unit 311 performs processing of S302.

Meanwhile, when a determination result in the processing of S301 is no, the position difference derivation unit 311 performs the processing of S301 again.

When performing the processing of S302, as the processing, the position difference derivation unit 311 reads out the latest position information and the latest estimated position information from the recording unit 386. The position information is received by the receiving unit 301 illustrated in FIG. 1 from the positioning device 200, and is stored in the recording unit 386. The estimated position information is stored in the recording unit 386 by the position estimation unit 326 through the processing illustrated in FIG. 3.

Next, as processing of S303, the position difference derivation unit 311 derives the difference information representing a difference between the position information and the estimated position information read in the processing of S302.

Then, as processing of S304, the position difference derivation unit 311 causes the recording unit 386 to store the difference information derived in the processing of S303.

Then, as processing of S305, the position difference derivation unit 311 performs determination as to whether to end the processing illustrated in FIG. 5. The position difference derivation unit 311 performs the determination, for example, by determining presence and absence of input of end information from outside.

When a determination result in the processing of S305 is yes, the position difference derivation unit 311 ends the processing illustrated in FIG. 5.

Meanwhile, when a determination result in the processing of S305 is no, the position difference derivation unit 311 performs the processing of S301 again.

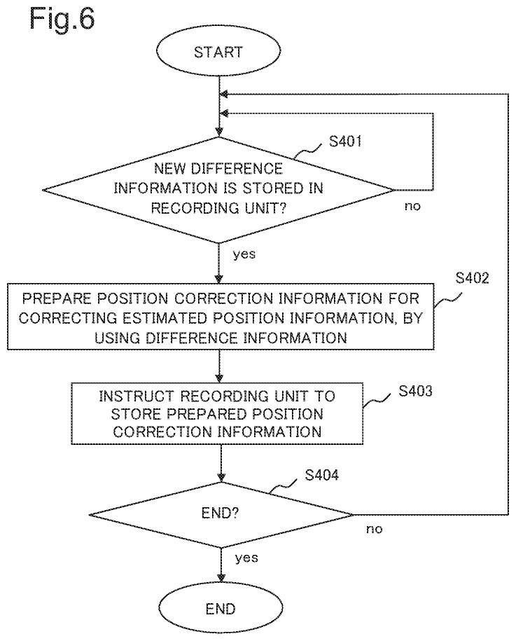

FIG. 6 is a conceptual diagram illustrating a processing flow example of processing performed by the position correction unit 306 illustrated in FIG. 1.

The position correction unit 306 starts the processing illustrated in FIG. 6, for example, upon input of start information from outside.

Then, as processing of S401, the position correction unit 306 performs determination as to whether the new difference information is stored in the recording unit 386. The difference information is stored in the recording unit 386 by the position difference derivation unit 311 through the processing illustrated in FIG. 5.

When a determination result in the processing of S401 is yes, the position correction unit 306 performs processing of S402.

Meanwhile, when a determination result in the processing of S401 is no, the position correction unit 306 performs the processing of S401 again.

When performing the processing of S402, as the processing, the position correction unit 306 reads out the latest difference information from the recording unit 386, and generates, by using the read out difference information, the above-described position correction information that is information for correcting an estimated position. A method of generating the position correction information is as described above.

Then, as processing of S403, the position correction unit 306 causes the recording unit 386 to store the position correction information generated in the processing of S402.

Then, as processing of S404, the position correction unit 306 performs determination as to whether to end the processing illustrated in FIG. 6. The position correction unit 306 performs the determination, for example, by determining presence and absence of input of end information from outside.

When a determination result in the processing of S404 is yes, the position correction unit 306 ends the processing illustrated in FIG. 6.

Meanwhile, when a determination result in the processing of S404 is no, the position correction unit 306 performs the processing of S401 again.

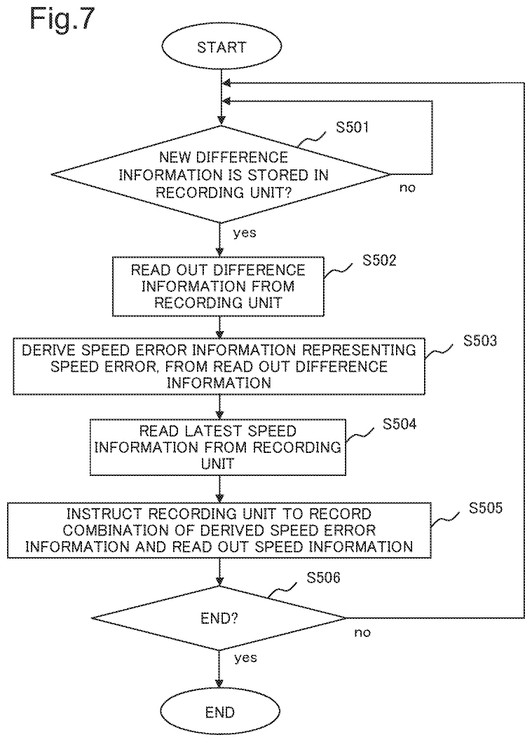

FIG. 7 is a conceptual diagram illustrating a processing flow example of processing performed by the speed error derivation unit 316 illustrated in FIG. 1.

The speed error derivation unit 316 starts the processing illustrated in FIG. 7, for example, upon input of start information from outside.

Then, as processing of S501, the speed error derivation unit 316 performs determination as to whether the new difference information is stored in the recording unit 386. The difference information is stored in the recording unit 386 by the position difference derivation unit 311 through the processing illustrated in FIG. 5.

When a determination result in the processing of S501 is yes, the speed error derivation unit 316 performs processing of S502.

Meanwhile, when a determination result in the processing of S501 is no, the speed error derivation unit 316 performs the processing of S501 again.

When performing the processing of S502, as the processing, the speed error derivation unit 316 reads out the latest difference information from the recording unit 386.

Then, as processing of S503, the speed error derivation unit 316 derives, from the difference information read out in the processing of S502, an error in speed information that is information representing a speed, and generates speed error information that is information representing the derived error. An example of a method of generating the speed error information is as described above.

Then, as processing of S504, the speed error derivation unit 316 reads, from the recording unit 386, the latest speed information held in the recording unit 386. The speed information is stored in the recording unit 386 by the speed derivation unit 331 through the processing illustrated in FIG. 4.

Then, as processing of S505, the speed error derivation unit 316 causes the recording unit 386 to store a combination of the speed error information derived in the processing of S503 and the speed information read in the processing of S504. When the speed error derivation unit 316 causes the recording unit 386 to store the combination, the speed error derivation unit 316 causes the recording unit 386 not to discard but to keep the previously stored combination. Thus, the recording unit 386 holds a combination group consisting of a plurality of the combinations stored at different times.

Then, as processing of S506, the speed error derivation unit 316 performs determination as to whether to end the processing illustrated in FIG. 7. The speed error derivation unit 316 performs the determination, for example, by determining presence and absence of input of end information from outside.

When a determination result in the processing of S506 is yes, the speed error derivation unit 316 ends the processing illustrated in FIG. 7.

Meanwhile, when a determination result in the processing of S506 is no, the speed error derivation unit 316 performs the processing of S501 again.

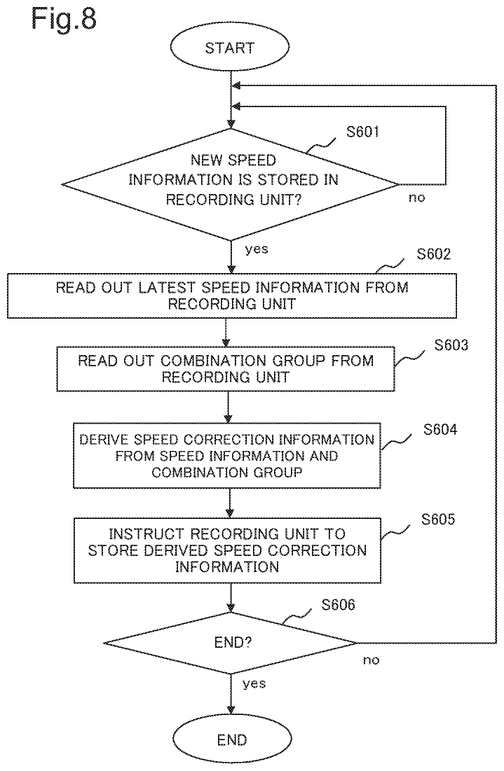

FIG. 8 is a conceptual diagram illustrating a processing flow example of processing performed by the speed correction derivation unit 321 illustrated in FIG. 1.

The speed correction derivation unit 321 starts the processing illustrated in FIG. 8, for example, upon input of start information from outside.

Then, as processing of S601, the speed correction derivation unit 321 performs determination as to whether the new speed information is stored in the recording unit 386. The speed information is stored in the recording unit 386 by the speed derivation unit 331 through the processing illustrated in FIG. 4.

When a determination result in the processing of S601 is yes, the speed correction derivation unit 321 performs processing of S602.

Meanwhile, when a determination result in the processing of S601 is no, the speed correction derivation unit 321 performs the processing of S601 again.

When performing the processing of S602, as the processing, the speed correction derivation unit 321 reads out the latest speed information from the recording unit 386.

Then, as processing of S603, the speed correction derivation unit 321 reads out the above-described combination group from the recording unit 386.

Then, as processing of S604, the speed correction derivation unit 321 derives the above-described speed correction information from the latest speed information read out in the processing of S602 and the combination group read out in the processing of S603. The speed correction information is information for correcting the latest speed information, as described above. An example of a method of deriving the speed correction information from the latest speed information and the combination group is as described above.

Then, as processing of S605, the speed correction derivation unit 321 causes the recording unit 386 to store the speed correction information derived in the processing of S604.

Then, as processing of S606, the speed correction derivation unit 321 performs determination as to whether to end the processing illustrated in FIG. 8. The speed correction derivation unit 321 performs the determination, for example, by determining presence and absence of input of end information from outside.

When a determination result in the processing of S606 is yes, the speed correction derivation unit 321 ends the processing illustrated in FIG. 8.

Meanwhile, when a determination result in the processing of S606 is no, the speed correction derivation unit 321 performs the processing of S601 again.

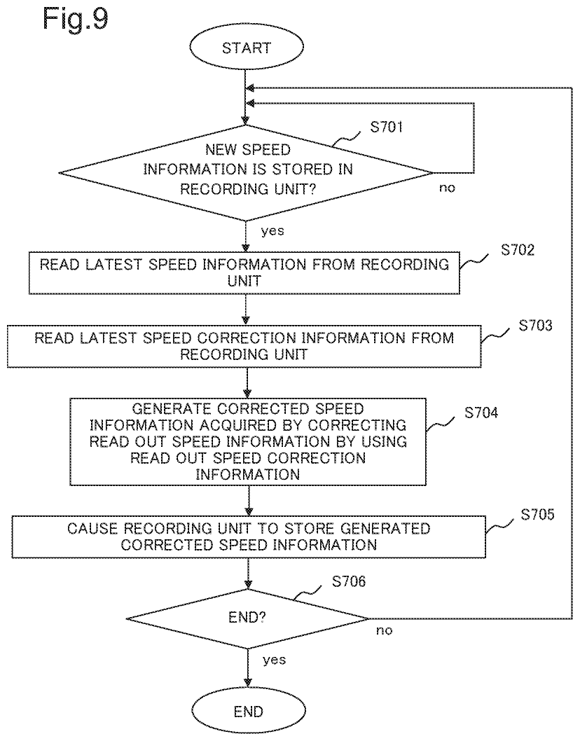

FIG. 9 is a conceptual diagram illustrating a processing flow example of processing performed by the speed correction unit 336 illustrated in FIG. 1.

The speed correction unit 336 starts the processing illustrated in FIG. 9, for example, upon input of start information from outside.

Then, as processing of S701, the speed correction unit 336 performs determination as to whether the new speed information is stored in the recording unit 386. The speed information is stored in the recording unit 386 by the speed derivation unit 331 through the processing illustrated in FIG. 4.

When a determination result in the processing of S701 is yes, the speed correction unit 336 performs processing of S702.

Meanwhile, when a determination result in the processing of S701 is no, the speed correction unit 336 performs the processing of S701 again.

When performing the processing of S702, as the processing, the speed correction unit 336 reads out the latest speed information from the recording unit 386.

Then, as processing of S703, the speed correction unit 336 reads out the latest speed correction information from the recording unit 386.

Then, as processing of S704, the speed correction unit 336 generates the corrected speed information acquired by correcting, using the speed correction information read out in the processing of S703, the latest speed information read out in the processing of S702.

Then, as processing of S705, the speed correction unit 336 causes the recording unit 386 to store the corrected speed information generated in the processing of S704.

Then, as processing of S706, the speed correction unit 336 performs determination as to whether to end the processing illustrated in FIG. 9. The speed correction unit 336 performs the determination, for example, by determining presence and absence of input of end information from outside.

When a determination result in the processing of S706 is yes, the speed correction unit 336 ends the processing illustrated in FIG. 9.

Meanwhile, when a determination result in the processing of S706 is no, the speed correction unit 336 performs the processing of S701 again.

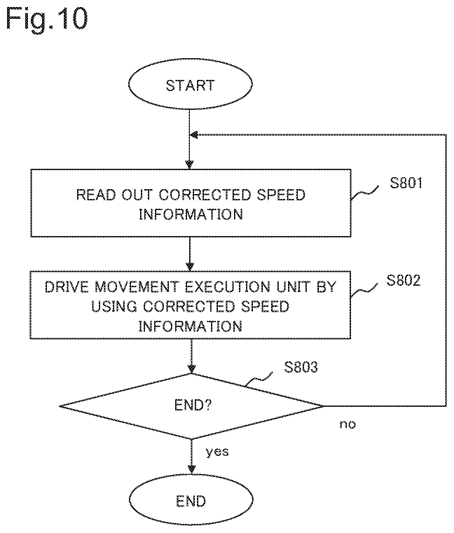

FIG. 10 is a conceptual diagram illustrating a processing flow example of processing performed by the drive unit 341 illustrated in FIG. 1.

The drive unit 341 starts the processing illustrated in FIG. 10, for example, upon input of start information from outside.

Then, as processing of S801, the drive unit 341 reads out the latest corrected speed information from the recording unit 386. The corrected speed information is stored in the recording unit 386 by the speed correction unit 336 through the processing illustrated in FIG. 9.

Then, as processing of S802, the drive unit 341 drives the drive wheels included in the movement execution unit 396 illustrated in FIG. 1, by using the corrected speed information read out in the processing of S801.

Then, as processing of S803, the drive unit 341 performs determination as to whether to end the processing illustrated in FIG. 10. The drive unit 341 performs the determination, for example, by determining presence and absence of input of end information from outside.

When a determination result in the processing of S803 is yes, the drive unit 341 ends the processing illustrated in FIG. 10.

Meanwhile, when a determination result in the processing of S803 is no, the drive unit 341 performs the processing of S801 again.

### Advantageous Effect

The mobile body system according to the first example embodiment corrects speed information representing a speed of a mobile body and derived from status information detected by a detection unit included in the mobile body, by using speed correction information derived from a relationship between the speed information and a speed error. Accordingly, the mobile body system performs movement control by using speed information closer to speed information actually necessary for movement, in comparison with a case where speed information is not corrected. Thus, the mobile body system can improve precision in movement control, in comparison with a case where speed information is not corrected. The case where speed information is not corrected is, for example, a case where positioning information is sent from an external positioning sensor to a mobile body via a wireless network in the method disclosed in PTL 1.

In addition to the above, the mobile body system derives the relationship from a combination of the speed information and the speed error acquired while a mobile body is moving. Thus, the mobile body system can derive the more practical speed correction information, in comparison with a case where the speed correction information is derived by using the preliminarily held relationship. Accordingly, the mobile body system can perform much higher-precision movement control of a mobile body, in comparison with a case where the speed correction information is derived by using the preliminarily held relationship.

Further, the mobile body system performs the correction more frequently than the derivation of the combination. By performing the correction frequently, an error in the speed information can be corrected when the error is small. Accordingly, the speed information after correction is much closer to information actually necessary for the movement, in comparison with a case where the correction is not more frequently performed than the derivation of the combination. Thus, the mobile body system can perform much higher-precision movement control of a mobile body, in comparison with a case where the correction is not more frequently performed than the derivation of the combination.

The mobile body may derive the combination from error information based on the position information arriving from a positioning device and the estimated position information derived earlier by communication delay time required for arrival of the position information from the positioning device via a wireless network. In the case, a derivation time at which the position information is derived by the positioning device is close to a derivation time at which the estimated position information is derived by the mobile body. In that case, the combination is closer to a correct value. Accordingly, in the case, precision of the relationship derived from a plurality of the combinations is improved. Thus, in the case, precision of the speed correction information derived from the relationship is improved. Accordingly, in the case, the speed information after correction is much closer to information actually necessary for the movement, in comparison with a case where the correction is not more frequently performed than the derivation of the combination. Thus, in the case, the mobile body system can perform much higher-precision movement control of a mobile body, in comparison with a case where communication time is not considered.

### Second Example Embodiment

A second example embodiment is an example embodiment relating to a mobile body system that is applicable when an error in a circumferential speed of each drive wheel has no linear relationship with the circumferential speed.

### [Configuration and Operation]

A configuration example of the mobile body system according to the second example embodiment is the same as the configuration example of the mobile body system according to the first example embodiment illustrated in FIG. 1.

Description of a mobile body system 100 according to the second example embodiment illustrated in FIG. 1 is different from the description of the mobile body system 100 according to the first example embodiment, regarding the following description.

An error in a circumferential speed of each drive wheel derived by a speed error derivation unit 316 illustrated in FIG. 1 is not always a linear value relative to the circumferential speed of each drive wheel. That case is a case where the circumferential speed changes discontinuously as the speed changes.

When the error deviates greatly from a linear value relative to the circumferential speed of each drive wheel, an error estimated value on the premise that the error is a linear value relative to the circumferential speed of each drive wheel as illustrated in FIG. 2 is incorrect. Thus, precision in correction of the circumferential speed is low. Examples of a method that can be applied even when the error is a nonlinear value relative to the circumferential speed of each drive wheel include, for example, the following method.

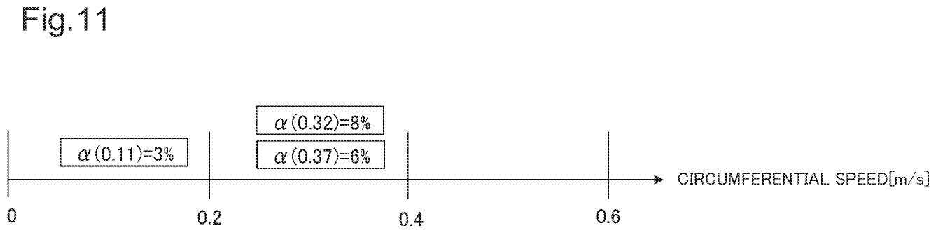

FIG. 11 is a conceptual diagram illustrating a method of deriving the speed correction information from the combination information.

In FIG. 11, it is presumed that the speed error derivation unit 316 causes a recording unit 386 to store the combination information consisting of the following three combinations. The first combination is a combination of a circumferential speed 0.11 m/s and a circumferential speed error α(0.11)=3%. The second combination is a combination of a circumferential speed 0.32 m/s and a circumferential speed error α(0.32)=8%. The third combination is a combination of a circumferential speed 0.37 m/s and a circumferential speed error α(0.37)=6%.

A speed correction derivation unit 321 illustrated in FIG. 1 reads out the combination group consisting of the combinations from the recording unit 386, and then classifies the combinations into ranges of the circumferential speed set in advance. Herein, the range is a range of the circumferential speed at which it is assumed that a mobile body can move, and is divided into a plurality of sections. Thus, the circumferential speed error α(0.11) is classified into a range of the circumferential speed 0 to 0.2 m/s, and the circumferential speed error α(0.32) and the circumferential speed error α(0.37) are classified into a range of the circumferential speed 0.2 to 0.4 m/s.

Then, the speed correction derivation unit 321 derives, from the circumferential speed error classified into each range, a circumferential speed correction value for the range. Herein, the circumferential speed correction value is a value represented by the above-described speed correction information.

At that time, the speed correction derivation unit 321 may derive, as the circumferential speed correction value for each range, a mean of the circumferential speed error classified into the range. In that case, the circumferential speed correction value associated with the range of the circumferential speed 0 to 0.2 m/s is 3%, and the correction value associated with the range of the circumferential speed 0.2 to 0.4 m/s is 7%.

Then, the speed correction derivation unit 321 causes the recording unit 386 to store the correction value associated with the range of the circumferential speed including the circumferential speed represented by the speed information read from the recording unit 386.

Herein, it may be presumed that, among the combinations stored in the recording unit 386 by the speed error derivation unit 316, the speed error included in the new combination is a more correct value in comparison with the speed error included in the old combination. In that case, when deriving the speed correction value associated with each range, the speed correction derivation unit 321 may give larger weight to the newer speed error.

The speed error derivation unit 316 may use a method of calculating an exponentially smoothed moving average relating to a storage time at which the combination is stored in the recording unit 386, in order to give larger weight to the new speed error.

The speed correction derivation unit 321 may use the Kalman filter, in order to give larger weight to the new speed error.

Except for the above, description of configurations in the mobile body system 100 illustrated in FIG. 1 is the same as the description of the configurations in the mobile body system 100 illustrated in FIG. 1. When the above description is inconsistent with the description of the first example embodiment, the above description is prioritized.

### Advantageous Effect

The mobile body system according to the second example embodiment applies a nonlinear error model, when deriving the speed correction information for correcting the speed information from the latest speed information of a mobile body and the combination group. The nonlinear model is based on the premise that the speed information changes nonlinearly as the speed changes. The combination group consists of combinations of the speed error of a mobile body and the circumferential speed or the like of a movement execution unit associated with the error. Thus, even when the circumferential speed or the like of the movement execution unit changes discontinuously, the mobile body system is able to bring the circumferential speed or the like closer to a value necessary for executing movement of a mobile body as planned. Thus, the mobile body system can perform higher-precision movement control of a mobile body, in comparison with a case where positioning information is sent via a wireless network in the method disclosed in PTL 1.

### Third Example Embodiment

A third example embodiment is an example embodiment relating to a mobile body system that derives communication delay in position information of a mobile body sent from a positioning device to the mobile body, and corrects estimated position information or the like by using the communication delay.

### [Configuration and Operation]

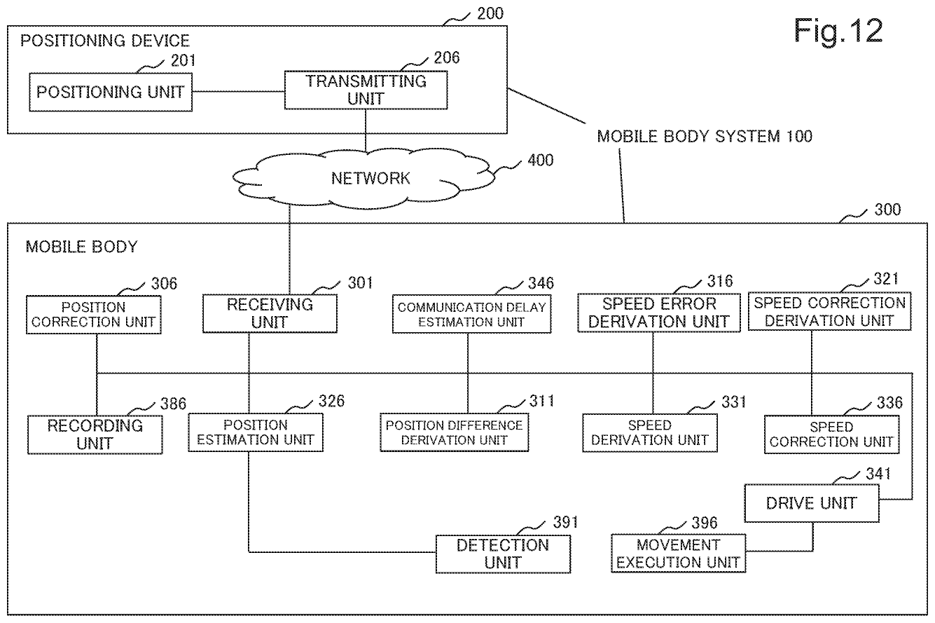

FIG. 12 is a conceptual diagram illustrating a configuration of a mobile body system 100 being an example of the mobile body system according to the third example embodiment.

In the mobile body system 100 illustrated in FIG. 12, a mobile body 300 included in the mobile body system 100 illustrated in FIG. 1 further includes a communication delay estimation unit 346, in addition to the configurations included in the mobile body system 100 illustrated in FIG. 1.

The position information sent by a positioning device 200 to the mobile body 300 via a network 400 is transmitted with delay due to various factors such as the network 400 and a use status of the network 400. By estimating communication delay time relating to the delay, higher-precision movement control of the mobile body 300 can be performed.

Herein, it is assumed that a clock included in the positioning device 200 and a clock included in the mobile body 300 are in synchronization with sufficient precision.

In that case, the positioning device 200 transmits, to the mobile body 300, a transmission time together with the position information.

A receiving unit 301 causes a recording unit 386 to hold the position information and the transmission time. At that time, the receiving unit 301 causes the recording unit 386 to store a reception time thereof.

The communication delay estimation unit 346 derives, from a difference between the transmission time and the reception time stored in the recording unit 386, communication delay time that is a period of time required for transmission of the position information. The communication delay estimation unit 346 causes the recording unit 386 to hold the derived communication delay time in combination with the position information relating to the communication delay time.

A position estimation unit 326 causes the recording unit 386 not to discard but to hold estimated position information derived in the past as well. Accordingly, the recording unit 386 holds an estimated position information group consisting of pieces of estimated position information derived at different times. Each piece of estimated position information included in the estimated position information is associated with a storage time relating to storage of the estimated position information in the recording unit 386.

A position difference derivation unit 311 reads, at the second timing, the position information and the communication delay time associated with the position information. Then, the position difference derivation unit 311 reads, from the recording unit 386, the estimated position information stored in the recording unit 386 earlier by the read communication delay time. Then, the position difference derivation unit 311 derives the difference information representing a difference between the position information and the estimated position information, and causes the recording unit 386 to hold the difference information. The difference information is a difference between the position information and the estimated position information at the same time or at times close to each other. Accordingly, the difference information is derived from a more appropriate target for deriving a difference, than the difference information between the latest estimated position information stored in the recording unit 386 and the latest position information stored in the recording unit 386.

An operation performed by a position correction unit 306, a speed error derivation unit 316, a speed correction derivation unit 321, a speed correction unit 336, a drive unit 341, and a movement execution unit 396 in the mobile body 300 is based on the difference information.

Thus, the mobile body system 100 illustrated in FIG. 12 enables higher-precision movement control of the mobile body 300, in comparison with the mobile body system 100 illustrated in FIG. 1.

Except for the above, description of configurations illustrated in FIG. 12 is the same as the description of the configurations illustrated in FIG. 1 according to the first example embodiment and the second example embodiment. When the above description is inconsistent with the description of the first example embodiment and the second example embodiment, the above description is prioritized.

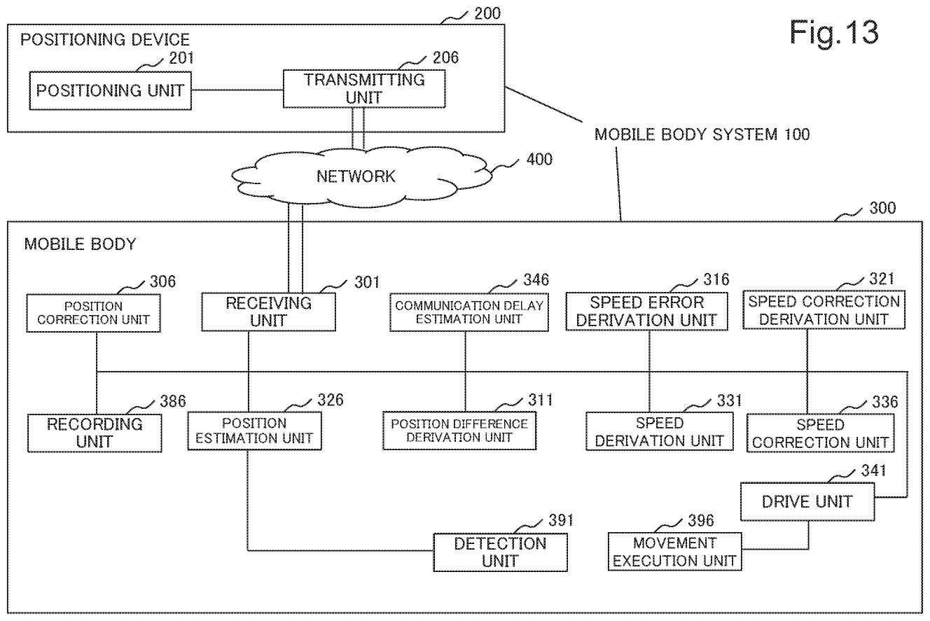

FIG. 13 is a conceptual diagram illustrating a configuration of a mobile body system 100 being a second example of the mobile body system according to the third example embodiment.

The mobile body system 100 is different from the mobile body system 100 illustrated in FIG. 12 in that a transmitting unit 206 included in a positioning device 200 and a receiving unit included in a mobile body 300 perform bidirectional communication. In FIG. 13, presence of two communication paths connecting between the transmitting unit 206 and the receiving unit 301 via a network 400 indicates that the bidirectional communication can be performed.

The receiving unit 301 illustrated in FIG. 13 sends transmission information for measuring delay time to the positioning device 200, at a third timing temporally denser than the above-described first timing. At that time, the receiving unit 301 causes a recording unit 386 to store a transmission time at which the transmission information is transmitted, in combination with identification information representing the transmission information.

When receiving the transmission information, the transmitting unit 206 in the positioning device 200 promptly transmits response information for the transmission information to the receiving unit 301.

When receiving the response information, the receiving unit 301 causes the recording unit 386 to store a reception time at which the response information is received, in combination with the transmission time at which the transmission information relating to the response information is transmitted.

When the recording unit 386 stores the reception time at which the response information is received, a communication delay estimation unit 346 derives, from a difference between the reception time and the transmission time associated with the reception time, communication delay time relating to a round-trip communication between the transmitting unit 206 and the receiving unit 301. The communication delay estimation unit 346 derives, from the derived round-trip communication delay time, communication delay time relating to a one-way communication from the transmitting unit 206 to the receiving unit 301. The communication delay estimation unit 346 derives, as the communication delay time relating to the one-way communication, for example, a half of the round-trip communication delay time. The communication delay estimation unit 346 causes the recording unit 386 to store the derived communication delay time relating to the one-way communication.

A position difference derivation unit 311 derives, at the first timing, a difference between the latest position information and the estimated position information held in the recording unit 386 earlier by the communication delay time relating to the latest one-way communication held in the recording unit 386.

With the above configuration, the mobile body system 100 illustrated in FIG. 13 can derive a difference in the position information in consideration of influence of the communication delay time, even when a time of a clock included in the positioning device 200 and a time of a clock included in the mobile body 300 are not in synchronization.

Except for the above, description of configurations in the mobile body system 100 illustrated in FIG. 13 is the same as the description of the mobile body system 100 illustrated in FIG. 12. When the description relating to FIG. 13 is inconsistent with the description relating to FIG. 12, the above description relating to FIG. 13 is prioritized.

### Advantageous Effect

The mobile body system according to the third example embodiment prepares a combination of speed information and error information, in consideration of influence of communication delay time relating to position information of a mobile body transmitted from a positioning device. Accordingly, the mobile body system can prepare the higher-precision combination, in comparison with the mobile body system according to the first example embodiment and the second example embodiment. Precision in movement control of a mobile body is dependent on precision of the combination. Thus, the mobile body system can perform higher-precision movement control of a mobile body, in comparison with the mobile body system according to the first example embodiment and the second example embodiment.

### Fourth Example Embodiment

A fourth example embodiment is an example embodiment relating to a mobile body system in which some configurations included in the mobile body according to the first to third example embodiments are included in a positioning device.

### [Configuration and Operation]

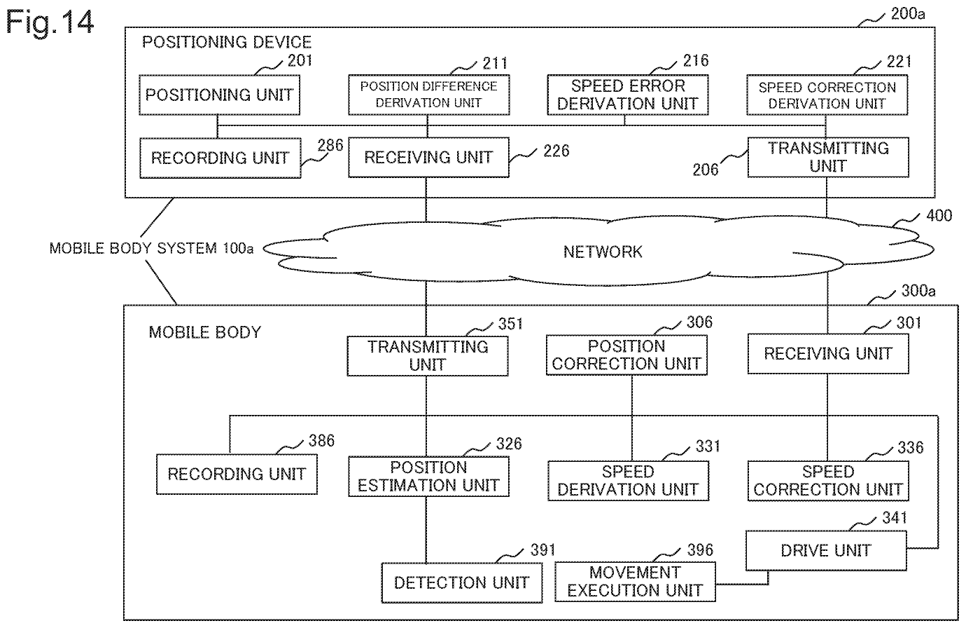

FIG. 14 is a conceptual diagram illustrating a configuration of a mobile body system 100a being an example of the mobile body system according to the fourth example embodiment.

The mobile body system 100a includes a positioning device 200a and a mobile body 300a.

The positioning device 200a includes a positioning unit 201, a transmitting unit 206, a position difference derivation unit 211, a speed error derivation unit 216, a speed correction derivation unit 221, a receiving unit 226, and a recording unit 286.

The positioning unit 201 stores, in the recording unit 286, derived position information representing a position of the mobile body 300. Except for the above, description of the positioning unit 201 is the same as the description of the positioning unit 201 illustrated in FIG. 1. When the above description is inconsistent with the description relating to FIG. 1, the above description is prioritized.

The receiving unit 226 stores, in the recording unit 286, pieces of information sent from the mobile body 300a via a network 400. The information includes estimated position information and speed information. The estimated position information is derived by a position estimation unit 326, as will be described later. The speed information is derived by a speed derivation unit 331, as will be described later.

As first processing, the position difference derivation unit 211 derives, at a first timing, difference position information representing a difference between the latest position information and the latest estimated position information held in the recording unit 286. The position difference derivation unit 211 causes the recording unit 286 to store the derived difference position information. At that time, the position difference derivation unit 211 may cause the recording unit 286 to discard the past difference position information.

When the new difference information is stored in the recording unit by the position difference derivation unit 211, the speed error derivation unit 216 derives a circumferential speed error in each of circumferential speeds of drive wheels. The speed error derivation unit 216 derives the speed error by using a method similar to the speed error derivation unit 316 illustrated in FIG. 1. The speed error derivation unit 216 causes the recording unit 286 to hold speed error information representing the derived error. At that time, the speed error derivation unit 216 causes the recording unit 286 to hold the derived speed error information in association with the latest speed information held in the recording unit 286. Even when the speed error derivation unit 216 causes the recording unit 286 to newly hold a combination of the speed error information and the speed information held in the recording unit 286, the speed error derivation unit 216 does not cause the recording unit 286 to discard the combination held in the recording unit 286 in the past. Consequently, the recording unit 286 holds a combination group consisting of the combinations stored at different times.

The speed correction derivation unit 221 reads, at the second timing, the latest speed information from the recording unit 286. Then, the speed correction derivation unit 221 derives speed correction information associated with the read speed information, from the combination group held in the recording unit 286 at the point of time. The speed correction derivation unit 221 derives the speed correction information by using a method similar to the method performed by the speed correction derivation unit 321 illustrated in FIG. 1.

The speed correction derivation unit 221 causes the recording unit 286 to hold the derived error information. At that time, the speed correction derivation unit 221 may cause the recording unit 286 to discard the past error information held in the recording unit 286. The speed correction derivation unit 221 causes the transmitting unit 206 to send the derived error information to the mobile body 300a.

The transmitting unit 206 sends information instructed by the configurations included in the positioning device 200a, to the mobile body 300a via the network 400. The information includes the error information derived by the speed correction derivation unit 221.

The recording unit 286 holds sent information, according to an instruction from the configurations. When storing information, the recording unit 286 holds a time relating to the storage, in combination with the information to be stored. The recording unit 286 discards held information instructed from the configurations. The recording unit 286 sends instructed information, according to an instruction from the configurations.

The mobile body 300 includes a receiving unit 301, a position correction unit 306, the position estimation unit 326, the speed derivation unit 331, a speed correction unit 336, a drive unit 341, a detection unit 391, a movement execution unit 396, and a recording unit 386.

The position estimation unit 326 causes a transmitting unit 351 to send derived estimated position information to the positioning device 200a.

The speed derivation unit 331 causes the transmitting unit 351 to send derived speed information to the positioning device 200a.

When the receiving unit 301 stores the new error information in the recording unit 386, the speed correction unit 336 generates corrected speed information acquired by correcting, using the error information, the latest speed information held in the recording unit 386, and causes the recording unit 386 to store the corrected speed information.

Except for the above, description of configurations in the mobile body 300a illustrated in FIG. 14 is the same as the description of the configurations illustrated in FIG. 1. When the above description is inconsistent with the description relating to FIG. 1, the above description is prioritized.

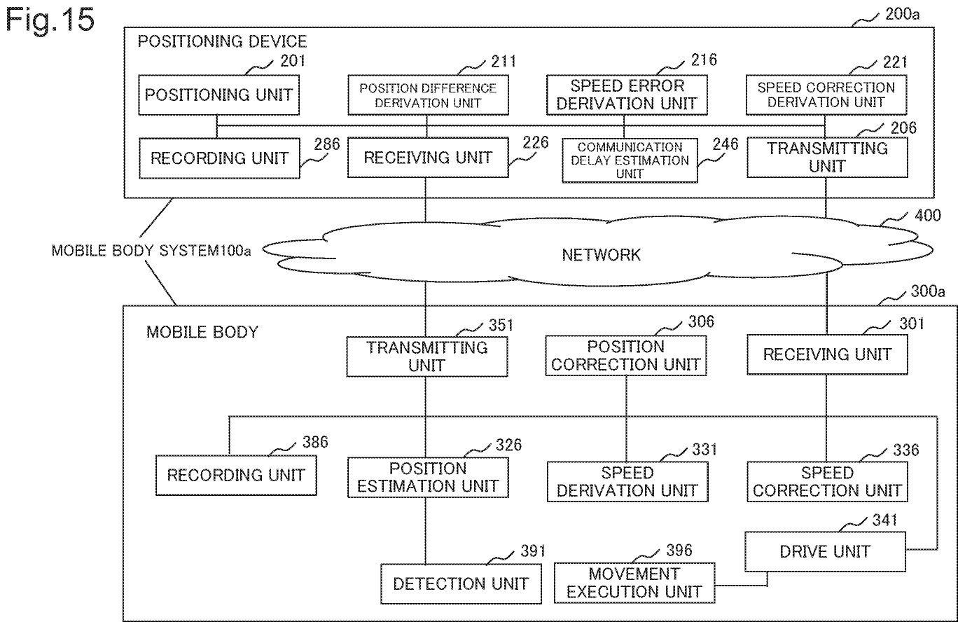

FIG. 15 is a conceptual diagram illustrating a configuration of a mobile body system 100a being a second example of the mobile body system according to the fourth example embodiment.

A positioning device 200a illustrated in FIG. 15 includes a communication delay estimation unit 246, in addition to the configurations included in the positioning device 200a illustrated in FIG. 14.

The communication delay estimation unit 246 derives one-way communication delay time relating to communication between the positioning device 200a and a mobile body 300a by using a method similar to the method described in the third example embodiment, and stores the one-way communication delay time in a recording unit 286.

A position difference derivation unit 211 derives difference information between the latest estimated position information stored in the recording unit 286 and the position information stored in the recording unit 286 earlier by the latest one-way communication delay time held in the recording unit 286.

The mobile body system 100a illustrated in FIG. 15 derives the difference information from the estimated position information and the position information at times closer to each other, by considering the communication delay time. Thus, the difference information has higher precision in comparison with the case illustrated in FIG. 14.

Speed control performed by the mobile body system 100a illustrated in FIG. 15 is performed based on the difference information. Accordingly, the mobile body system 100a illustrated in FIG. 15 enables higher-precision speed control, in comparison with the mobile body system 100a illustrated in FIG. 14.

Except for the above, description of the mobile body system 100a illustrated in FIG. 15 is the same as the description of the mobile body system 100a illustrated in FIG. 14. When the above description is inconsistent with the description relating to FIG. 14, the above description is prioritized.

### Advantageous Effect

The mobile body system according to the fourth example embodiment performs processing similar to the processing performed by the mobile body system according to the first to third example embodiments, and exhibits an advantageous effect similar to the advantageous effect exhibited by the mobile body system according to the first to third example embodiments.

In the mobile body system according to the fourth example embodiment, error information used for correcting speed information is derived by a positioning device rather than a mobile body. Thus, the mobile body system according to the fourth example embodiment exhibits an advantageous effect that a processing load relating to processing in a mobile body can be reduced.

In the above, although description has been given mainly of an example of a case where a mobile body includes a movement execution unit that includes drive wheels of a two-wheeled shaft (in which the drive wheels are the movement enabling units), the mobile body may include a movement execution unit other than the above.

As an example of such a case, a case is assumed in which a mobile body includes a movement means similar to an automobile or a motorcycle. In that case, the mobile body includes, as a movement execution unit, a steering means for changing a direction of at least one wheel, and at least one drive wheel. In that case, the steering means and the drive wheel are the movement enabling units. The wheel and the drive wheel may be the same or may be different from each other.

In the case, the above-described status information is, for example, a combination of a steering angle at which the steering means changes a direction of the wheel and a rotation amount of the drive wheel. The speed information is information representing the steering angle and a circumferential speed of the drive wheel. The speed error is a combination of an error in the steering angle and an error in the circumferential speed. The speed correction information is a combination of information representing a correction value for the steering angle and information representing a correction value for the circumferential speed. The corrected speed information is a combination of the steering angle after correction corrected by using the correction value for the steering angle and the circumferential speed after correction corrected by using the correction value for the circumferential speed.

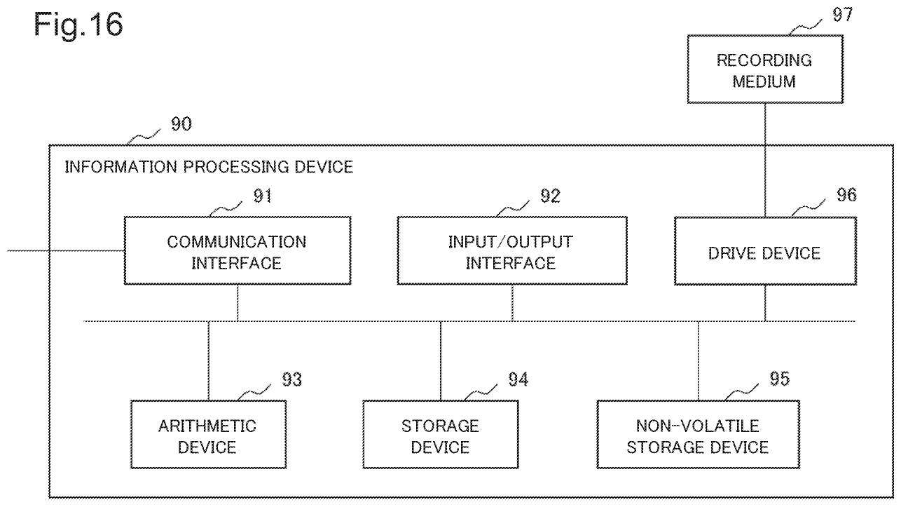

FIG. 16 is a conceptual diagram illustrating a hardware configuration example of an information processing device that can achieve a part for performing information processing and communication in a positioning device and a mobile body according to each of the example embodiments. An information processing device 90 includes a communication interface 91, an input/output interface 92, an arithmetic device 93, a storage device 94, a non-volatile storage device 95, and a drive device 96.

The communication interface 91 is a communication means for a communication device according to each of the example embodiments to communicate by wire or/and wirelessly with an external device. When the communication device is achieved by using at least two information processing devices, the devices may be connected in a mutually communicable way via the communication interface 91.

The input/output interface 92 is a man-machine interface such as a keyboard being one example of an input device or a display as an output device.

The arithmetic device 93 is an arithmetic processing device such as a general-purpose central processing unit (CPU) or a microprocessor. The arithmetic device 93 is able to read out, for example, various types of programs stored in the non-volatile storage device 95 into the storage device 94, and is able to execute processing according to the read out program.

The storage device 94 is a memory device that can be referred from the arithmetic device 93, such as a random access memory (RAM), and stores a program, various types of data, and the like. The storage device 94 may be a volatile memory device.

The non-volatile storage device 95 is, for example, a non-volatile storage device such as a read only memory (ROM) or a flash memory, and is able to store various types of programs, data, and the like.

The drive device 96 is, for example, a device that performs read and write of data on a recording medium 97 to be described later.

The recording medium 97 is, for example, any recording medium capable of recording data, such as an optical disk, a magneto-optical disk, or a semiconductor flash memory.

Each of the example embodiments of the present invention may be achieved, for example, by configuring a communication device with the information processing device 90 exemplified in FIG. 16 and supplying the communication device with a program capable of implementing the functions described in each of the above-described example embodiments.

In the case, the example embodiment may be achieved by the arithmetic device 93 executing the program supplied for the communication device. Some, rather than all, of the functions of the communication device may be configured with the information processing device 90.

Further, configuration may be made in such a way that the above-described program is recorded in the recording medium 97 and the above-described program is stored in the non-volatile storage device 95 as appropriate in a shipping stage, an operation stage, or the like of the communication device. In the case, a method of supplying the above-described program may employ a method of installing the program on the communication device by using an appropriate jig in a manufacture stage before shipping, an operation stage, or the like. A method of supplying the above-described program may employ a common procedure such as a method of downloading the program from outside via a communication line such as the Internet.

The above-described example embodiments are preferred example embodiments of the present invention, and various changes may be made therein without departing from the gist of the present invention.

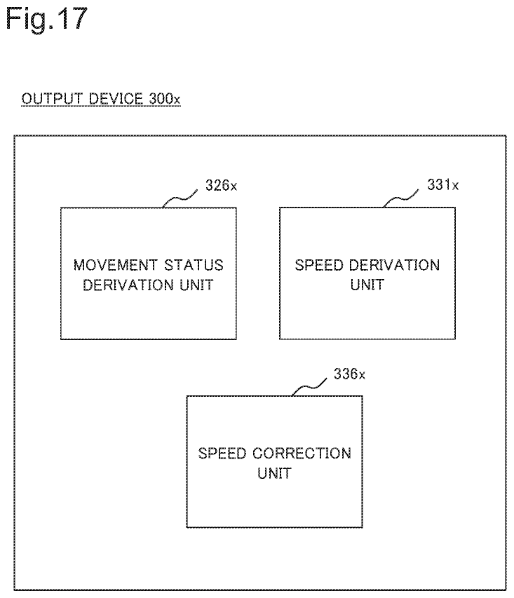

FIG. 17 is a block diagram illustrating a minimum configuration of an output device according to the example embodiment.

An output device 300x includes a movement status derivation unit 326x, a speed derivation unit 331x, and a speed correction unit 336x.

The movement status derivation unit 326x derives first status information that is information representing a movement status of a mobile body and is derived from status information representing an execution status of an operation for movement of the mobile body being performed by each of movement enabling units executing the movement.

The speed derivation unit 331x derives, from the first status information, speed information that is information representing a speed of the movement being enabled by each of the movement enabling units.

The speed correction unit 336x corrects the latest speed information from the latest speed information and a relationship between the speed information and error information representing an error in the speed information, and outputs corrected speed information that is the speed information after correction.

The output device 300x corrects the latest speed information, based on the relationship and the latest speed information. Thus, the output device 300x can improve precision of the speed information that is information for controlling movement of a mobile body.

Thus, with the configuration, the output device 300x exhibits the advantageous effect described in paragraphs of [Advantageous Effects of Invention].

While the example embodiments of the present invention have been described, the present invention is not limited to these example embodiments. Further modification, substitution, and adjustment may be made therein without departing from the basic technical idea of the present invention. For example, the configuration of the element illustrated in the drawings is one example for helping understanding of the present invention, and the present invention is not limited to the configuration illustrated in the drawings.

The whole or part of the example embodiments disclosed above can be described as, but not limited to, the following supplementary notes.

### (Supplementary Note 1)

An output device including:

a movement status derivation unit deriving first status information that is information representing a movement status of a mobile body and is derived from status information representing an execution status of an operation for movement of the mobile body being performed by each of movement enabling units executing the movement;

a speed derivation unit deriving, from the first status information, speed information that is information representing a magnitude and a direction of a speed of the movement being enabled by each of the movement enabling units; and

a speed correction unit correcting the latest speed information from the latest speed information and a relationship between the speed information and error information representing an error in the speed information, and outputting corrected speed information that is the speed information after correction.

### (Supplementary Note 2)

The output device according to Supplementary note 1, further including:

a speed error derivation unit deriving the error information from the first status information and second status information that is information representing the movement status acquired by an acquisition unit outside the mobile body and sent through communication of a wireless network, and causing a storage unit to store a combination of the error information and the speed information at a time of deriving the error information; and

a relationship derivation unit deriving the relationship from a plurality of the combinations previously stored in the storage unit.

### (Supplementary Note 3)

The output device according to Supplementary note 2, wherein the output is more frequently performed than the storage.

### (Supplementary Note 4)

The output device according to Supplementary note 2 or 3, wherein the speed correction unit derives the corrected speed information, by correcting the speed information by using speed correction information that is information for correcting the speed information and is derived by linear approximation of the combination belonging to a group of the combinations.

### (Supplementary Note 5)

The output device according to any one of Supplementary notes 2 and 3, wherein the speed correction unit derives the corrected speed information, by classifying the combination belonging to a group of the combinations into predetermined ranges and correcting the speed information by using speed correction information that is information for correcting the speed information and is derived from each of the ranges.

### (Supplementary Note 6)

The output device according to any one of Supplementary notes 2 to 5, wherein the speed error derivation unit derives the error information from the latest first status information and the latest second status information.

### (Supplementary Note 7)

The output device according to any one of Supplementary notes 2 to 6, further including a delay derivation unit deriving communication delay time relating to the communication, wherein

the speed error derivation unit derives the error information from the latest first status information and the second status information received earlier by a period of time substantially equal to the communication delay time through the communication.

### (Supplementary Note 8)

The output device according to any one of Supplementary notes 2 to 7, wherein the speed error derivation unit derives the error information from difference information representing a difference between the first status information and the second status information.

### (Supplementary Note 9)

The output device according to any one of Supplementary notes 2 to 8, further including a correction unit correcting the first status information by using the second status information.

### (Supplementary Note 10)

The output device according to any one of Supplementary notes 2 to 9, wherein the speed error derivation unit is included in the mobile body.

### (Supplementary Note 11)

The output device according to any one of Supplementary notes 2 to 9, wherein the speed error derivation unit is included in a second movement information derivation device that derives the second status information and sends the second status information to the mobile body.

### (Supplementary Note 12)

The output device according to any one of Supplementary notes 1 to 11, wherein the movement status is a position where the mobile body is present.

### (Supplementary Note 13)

The output device according to any one of Supplementary notes 1 to 12, wherein the movement enabling units are drive wheels constituting a two-wheeled shaft, and the status information is information representing a number of rotations of each of the drive wheels.

### (Supplementary Note 14)

The output device according to Supplementary note 13, wherein the speed information is information representing a circumferential speed of each of the drive wheels.

### (Supplementary Note 15)

The output device according to any one of Supplementary notes 1 to 12, wherein the movement enabling units include a direction operation unit determining a direction of the movement and a drive wheel for the movement, and the status information includes information representing an angle being operated by the direction operation unit and information representing a number of rotations of the drive wheel.

### (Supplementary Note 16)

The output device according to Supplementary note 15, wherein the speed information is information representing the angle and a circumferential speed of the drive wheel.

### (Supplementary Note 17)

The output device according to any one of Supplementary notes 1 to 16, wherein the status information is derived inside the mobile body.

### (Supplementary Note 18)

The output device according to any one of Supplementary notes 1 to 17, wherein the movement status derivation unit is included in the mobile body.

### (Supplementary Note 19)

The output device according to any one of Supplementary notes 1 to 18, wherein the speed derivation unit is included in the mobile body.

### (Supplementary Note 20)

The output device according to any one of Supplementary notes 1 to 19, wherein the speed correction unit is included in the mobile body.

### (Supplementary Note 21)

A drive device including: the output device according to any one of Supplementary notes 1 to 20; and a drive unit driving each of the movement enabling units by using the corrected speed information.

### (Supplementary Note 22)

A mobile device including: the drive device according to Supplementary note 21; and the movement enabling units.

### (Supplementary Note 23)

The mobile device according to Supplementary note 22, wherein the mobile device is the mobile body.

### (Supplementary Note 24)

A mobile body system including: the output device according to any one of Supplementary notes 2 to 11; a drive unit driving each of the movement enabling units by using the corrected speed information; the movement enabling units; and the acquisition unit.

### (Supplementary Note 25)

An output method including:

deriving first status information that is information representing a movement status of a mobile body and is derived from status information representing an execution status of an operation for movement of the mobile body being performed by each of movement enabling units executing the movement;

deriving, from the first status information, speed information that is information representing a magnitude and a direction of a speed of the movement being enabled by each of the movement enabling units; and

correcting the latest speed information from the latest speed information and a relationship between the speed information and error information representing an error in the speed information, and outputting corrected speed information that is the speed information after correction.

### (Supplementary Note 26)

An output program causing a computer to execute:

processing of deriving first status information that is information representing a movement status of a mobile body and is derived from status information representing an execution status of an operation for movement of the mobile body being performed by each of movement enabling units executing the movement;

processing of deriving, from the first status information, speed information that is information representing a magnitude and a direction of a speed of the movement being enabled by each of the movement enabling units; and

processing of correcting the latest speed information from the latest speed information and a relationship between the speed information and error information representing an error in the speed information, and outputting corrected speed information that is the speed information after correction.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-104348, filed on May 31, 2018, the disclosure of which is incorporated herein in its entirety by reference.

### REFERENCE SIGNS LIST

90 Information processing device
91 Communication interface
92 Input/output interface
93 Arithmetic device
94 Storage device
95 Non-volatile storage device
96 Drive device
97 Recording medium
100, 100a Mobile body system
200, 200a Positioning device
201 Positioning unit
206 Transmitting unit
211, 311 Position difference derivation unit
216, 316 Speed error derivation unit
221, 321 Speed correction derivation unit
226 Receiving unit
246, 346 Communication delay estimation unit
300, 300a Mobile body
301 Receiving unit
306 Position correction unit
326 Position estimation unit
331 Speed derivation unit
336 Speed correction unit
341 Drive unit
286, 386 Recording unit
391 Detection unit
396 Movement execution unit
400 Network

1. An output device comprising:
movement status a derivation unit configured to derive first status information that is information representing a movement status of a mobile body and is derived from status information representing an execution status of an operation for movement of the mobile body being performed by each of movement enabling units configured to execute the movement;
a speed derivation unit configured to derive, from the first status information, speed information that is information representing a magnitude and a direction of a speed of the movement being enabled by each of the movement enabling units; and
a speed correction unit configured to correct the latest speed information from the latest speed information and a relationship between the speed information and error information representing an error in the speed information, and configured to output corrected speed information that is the speed information after correction.

2. The output device according to claim 1, further comprising:
a speed error derivation unit configured to derive the error information from the first status information and second status information that is information representing the movement status acquired by an acquisition unit outside the mobile body and sent through communication of a wireless network, and configured to cause storage unit to store a combination of the error information and the speed information at a time of deriving the error information; and
a relationship derivation unit configured to derive the relationship from a plurality of the combinations previously stored in the storage unit.

3. The output device according to claim 2, wherein the output is more frequently performed than the storage.

4. The output device according to claim 2, wherein the speed correction unit derives the corrected speed information, by correcting the speed information by using speed correction information that is information for correcting the speed information and is derived by linear approximation of the combination belonging to a group of the combinations.

5. The output device according to claim 2, wherein the speed correction unit derives the corrected speed information, by classifying the combination belonging to a group of the combinations into predetermined ranges and correcting the speed information by using speed correction information that is information for correcting the speed information and is derived from each of the ranges.

6. The output device according to claim 2, wherein the speed error derivation unit derives the error information from the latest first status information and the latest second status information.

7. The output device according to claim 2, further comprising a delay derivation unit configured to derive communication delay time relating to the communication, wherein
the speed error derivation unit derives the error information from the latest first status information and the second status information received earlier by a period of time substantially equal to the communication delay time through the communication.

8. The output device according to claim 2, wherein the speed error derivation unit derives the error information from difference information representing a difference between the first status information and the second status information.

9. The output device according to claim 2, further comprising a correction unit configured to correct the first status information by using the second status information.

10. The output device according to claim 2, wherein the speed error derivation unit is included in the mobile body.

11. The output device according to claim 2, wherein the speed error derivation unit is included in a second movement information derivation device that derives the second status information and sends the second status information to the mobile body.

12. The output device according to claim 1, wherein the movement status is a position where the mobile body is present.

13. The output device according to claim 1, wherein the movement enabling units are drive wheels constituting a two-wheeled shaft, and the status information is information representing a number of rotations of each of the drive wheels.

14. The output device according to claim 13, wherein the speed information is information representing a circumferential speed of each of the drive wheels.

15. The output device according to claim 1, wherein the movement enabling units include a direction operation unit configured to determine a direction of the movement and a drive wheel for the movement, and the status information includes information representing an angle being operated by the direction operation unit and information representing a number of rotations of the drive wheel.

16. The output device according to claim 15, wherein the speed information is information representing the angle and a circumferential speed of the drive wheel.

17. The output device according to claim 1, wherein the status information is derived inside the mobile body.

18. The output device according to claim 1, wherein at least one of the movement status derivation unit, the speed derivation unit and the speed correction unit is included in the mobile body.

19.-24. (canceled)

25. An output method comprising:
deriving first status information that is information representing a movement status of a mobile body and is derived from status information representing an execution status of an operation for movement of the mobile body being performed by each of movement enabling units configured to execute the movement;
deriving, from the first status information, speed information that is information representing a magnitude and a direction of a speed of the movement being enabled by each of the movement enabling units; and
correcting the latest speed information from the latest speed information and a relationship between the speed information and error information representing an error in the speed information, and outputting corrected speed information that is the speed information after correction.

26. A non-transitory computer readable medium on which an output program is recorded, the output program causing a computer to execute:
processing of deriving first status information that is information representing a movement status of a mobile body and is derived from status information representing an execution status of an operation for movement of the mobile body being performed by each of movement enabling units configured to execute the movement;
processing of deriving, from the first status information, speed information that is information representing a magnitude and a direction of a speed of the movement being enabled by each of the movement enabling units; and
processing of correcting the latest speed information from the latest speed information and a relationship between the speed information and error information representing an error in the speed information, and outputting corrected speed information that is the speed information after correction.
